(19) United States
(12) Patent Application Publication
(10) Pub. No.: US 2006/0271491 A1
(43) Pub. Date: Nov. 30, 2006

(54) Apparatus and method for a software catalog having proxy entries

(75) Inventors: Barbara Ann Lois Ballard, Mantorville, MN (US); David Joseph Gimpl, Rochester, MN (US); Robert Joseph Padzieski, Rochester, MN (US); Tammy Lynn Van Hove, Elgin, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/138,818

(22) Filed: May 26, 2005

(51) Int. Cl. G06Q 99/00

(52) U.S. Cl. 705/57

(57) ABSTRACT

An apparatus and method to improve order fulfilment and the management of installed software on a computer system. In preferred embodiments, a software catalog provides a proxy entry to a CD image stored on a system resource. When the proxy entry is selected by the computer user, the proxy entry is materialized, it is changed into an actual image of the software on the user's computer ready for use. In preferred embodiments, the proxy entry includes installation information. In other preferred embodiments, the software catalog is used in a system for the management of software installation and order fulfilment of purchased software. The proxy entry may also include ownership information such as a key or certificate to increase security from software piracy.

### BACKGROUND OF THE INVENTION

1. Technical Field

This invention generally relates to computer systems, and more specifically relates to apparatus and methods for providing software fulfilment in a computer system via software catalog proxy entries to improve the process of accessing and using software.

2. Background Art

A desktop computer may be used for a number of different tasks. Computer users often have changing needs for the software installed on a specific computer system to perform these different tasks. In many computer network environments, there are a large number of computer systems that must be maintained and serviced. Computer system operators must load and install many different computer applications on multiple user's machines. Further, software applications are expensive and often require large amounts of memory for installation so it is not feasible to simply install all software that may be needed in the future. Also, manual installation of software applications uses a great deal of costly system operator time.

One method for software installation and management that is used in some computer system environments is through a software catalog. A prior art software catalog may list one or more entries that correspond to software stored in CD volumes on a system resource available to the computer. The CD volumes may reside in a system resource such as a CD jukebox or as CD images stored remotely such as on a network file server. The entries in the catalog contain links to the CD volumes. The software stored in the CD volumes is typically stored in industry standard formats such as ISO or UDF.

FIG. 2 illustrates a prior art software catalog system 200. A software catalog 210 resides in a computer's memory and contains a number of entries that point to corresponding software on a system resource such as a direct access storage device (DASD) 220 or a remote network server. The CD entries 230 typically include a map to one or more CD volumes on the system resource where the corresponding software is stored. The CD entry 220 of the prior art typically does not contain any installation information.

Computer software vendors increasingly need a timely and efficient way to distribute software. Quick delivery is important to ensure consideration by the software purchaser or user in comparison to competing products. In response to these emerging needs, a good deal of software is now being made available for purchase over the internet. Software for purchase over the internet is packaged in a different format than that distributed on CDs or DVDs to effectuate order fulfilment, the process to download and install the software. This difference in packaging requirements for internet distributed software increases the costs for software vendors.

Without a way to more efficiently manage software installation and order fulfilment, the computer software industry will continue to suffer from inefficiency and unnecessary product installation and distribution costs.

### DISCLOSURE OF INVENTION

In accordance with the preferred embodiments, an apparatus and method improves order fulfilment and the management of installed software on a computer system. In preferred embodiments, a software catalog provides one or more proxy entries to a CD image stored on a system resource. When the software corresponding to the proxy entry is needed, the proxy entry is selected by the computer user, the proxy entry is materialized, which means the proxy entry is changed into an actual image of the software on the user's computer ready for use. In preferred embodiments, the proxy entry includes installation information.

In preferred embodiments, the software catalog is used in a system for the management of software installation and order fulfilment of purchased software.

In other embodiments, the proxy entry includes ownership information such as a key or certificate to increase security from software piracy.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is an apparatus in accordance with the preferred embodiments;

FIG. 2 illustrates a software catalog according to the prior art;

FIG. 3 is an example of a software catalog according to preferred embodiments;

FIG. 4 is an example of a software catalog according to preferred embodiments;

FIG. 5 is an example of a software catalog according to preferred embodiments;

FIG. 6 is an example of a software catalog according to preferred embodiments;

FIG. 7 is an example of a software catalog according to preferred embodiments;

FIG. 8 illustrates an install engine according to the prior art;

FIG. 9 illustrates an install engine according to the prior art;

FIG. 10 is an example of an install engine for a software catalog according to preferred embodiments; and

FIG. 11 is a flow diagram illustrating a method according to the preferred embodiments.

### BEST MODE FOR CARRYING OUT THE INVENTION

An apparatus and method to improve order fulfilment and the management of installed software on a computer system is described herein. In preferred embodiments, a software catalog provides one or more proxy entries to a CD image stored on a system resource. When the proxy entry is selected by the computer user, the proxy entry is materialized, which means it is changed into an actual image of the software on the user's computer ready for use. The described software catalog operates on a general purpose computer such as a personal computer.

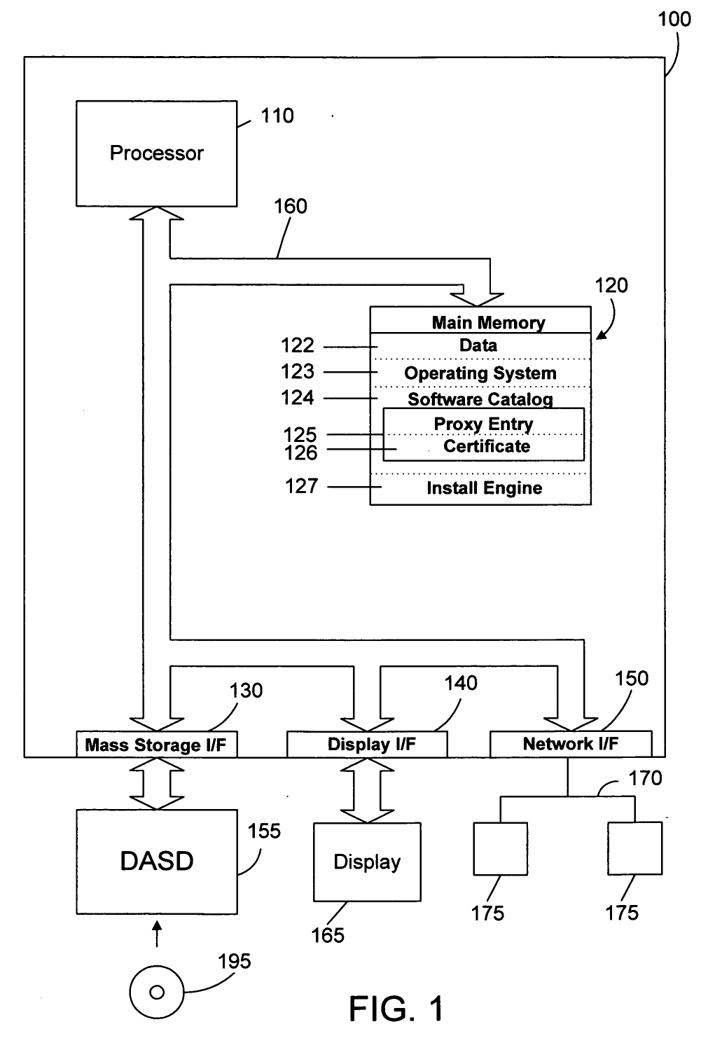

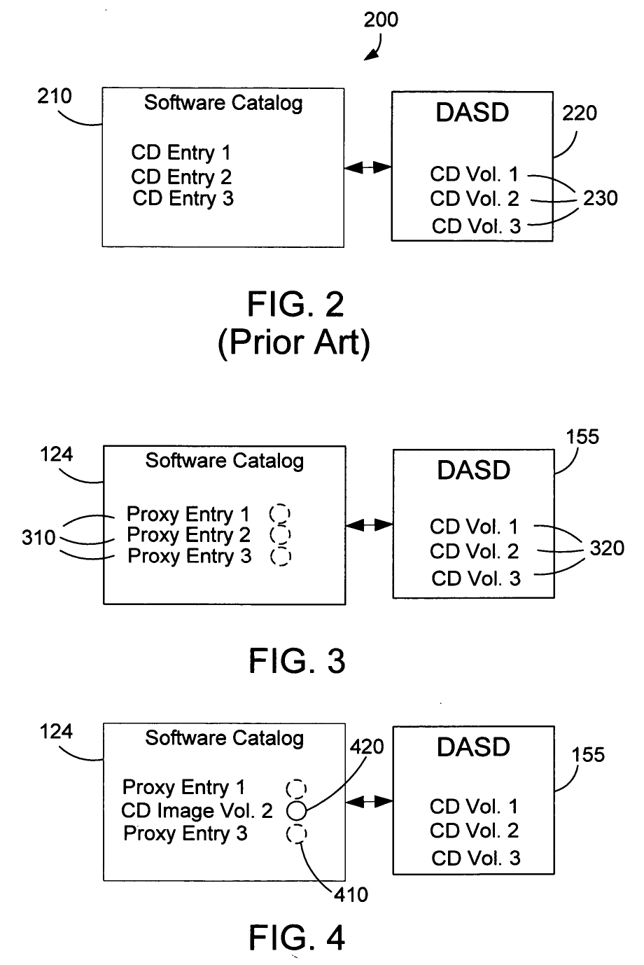

Referring now to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 122, an operating system 123, a software catalog 124, and an install engine 127. Data 122 represents any data that serves as input to or output from any program in computer system 100. Operating system 123 is a multitasking operating system known in the industry as i5/OS; however, those skilled in the art will appreciate that the spirit and scope of the present invention is not limited to any one operating system. Software catalog 124 includes one or more proxy entries 125 in accordance with the preferred embodiments described further below. The proxy entry may include ownership information, which includes information such as a key or certificate 126 to increase security from software piracy. The install engine 127 is software to install a software package from a software image as described below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 122, operating system 123, and software catalog 124 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 123. Operating system 123 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links.

Referring now to FIG. 3, an example of a software catalog 124 is represented in accordance with preferred embodiments. The software catalog 124 resides in the memory of a computer 100 as described above with reference to FIG. 1. The software catalog 124 contains a number of proxy entries that correspond to a number of software applications that are available for use on the computer. Whether the software actually resides on the computer may not necessarily be apparent to the user. Each of the proxy entries 310 contain information about the software's location and installation. The software may actually be located on a system resource such as a direct access storage device (DASD) 155. The DASD that holds the software may reside on another computer and be accessible over a network. Thus the DASD shown may be a storage device on a remote network server (not shown).

The proxy entries 310 are mapped or otherwise point to software images. The software images are packages of loadable software that is stored in a standardized format for installation. In the preferred embodiments, the software images are CD volume images 320. The CD images typically include one or more CD volumes on the system resource where the corresponding software is stored.

A proxy entry 310 is a placeholder entry within the software catalog that identifies where the software is located along with access information as to how to obtain and load the corresponding software. When the proxy entry is activated, the proxy entry materializes itself to a real entry of the software catalog. Materialization means the software catalog uses the information in the proxy entry to access the corresponding software and install it according to the parameters stored in the proxy entry such that the software is available for use and responds to a data request by the user. The proxy entry can be activated immediately by the user such as by clicking on the proxy entry in the software catalog. In other cases the proxy entry may be activated by a background type command so that the materialization is completed at night or some other time.

FIG. 4 represents an example of a software catalog 124 in accordance with preferred embodiments. When a proxy entry is activated, it then is materialized and stored as a software image rather than a proxy entry in the software catalog. The proxy entry “Proxy entry 2” shown in FIG. 3 is shown after undergoing activation and materialization as a software entry represented by “CD Image 2” in FIG. 4. The software catalog 124 now contains the software corresponding to the “Proxy entry 2”.

FIG. 4 illustrates another feature of a preferred embodiment. As shown in FIG. 4, a visual change can be made in a user interface view of the software catalog to indicate to a user or software administrator that the proxy entry has been materialized. The visual change can be a mnemonics change or an icon change. In the illustrated embodiment, the icon is shown as a shadow CD icon 410 for CD proxies that have not been materialized, and as a solid CD icon 420 for materialized proxies. The feature of displaying which proxy entries have been materialized would assist a user or administrator to evaluate the system resources an determine which software proxies may need to be dematerialized as described further below.

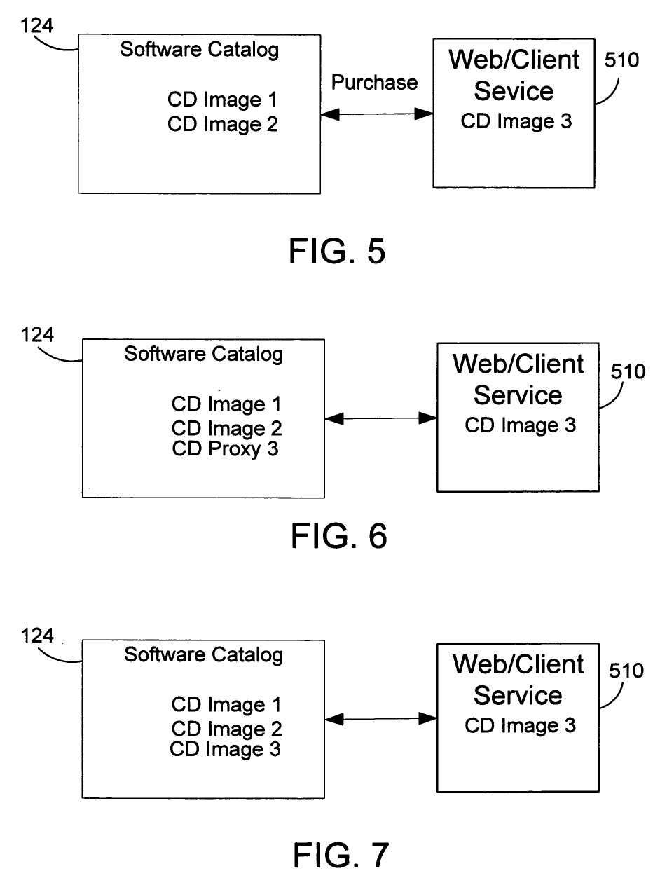

FIGS. 5, 6 and 7 illustrate another example of a software catalog 124 in accordance with preferred embodiments. In FIG. 5, the software catalog 124 shows that two software applications are available in CD Image 1 and CD Image 2. The computer user can utilize a web browser or a client service 510 to identify a software package shown as CD Image 3. The software package CD Image 3 can be in an industry standard format such as ISO or UDF. When the computer user completes a purchase procedure, a CD Proxy 3 is immediately downloaded into the software catalog 124 as shown in FIG. 6. Since the CD proxy is relatively small in size, the download can be virtually instantaneous. The order process includes inserting the proxy entry into the catalog so the user can immediately go from the task of buying the software to using the software with a catalog entry that manages itself. However, at this point the CD proxy 3 has not been materialized. When the CD Proxy 3 is activated, the proxy entry is materialized and the software package associated with CD Proxy 3 is loaded into the computer as described above. The CD Image 3 is then represented in the software catalog as shown in FIG. 7.

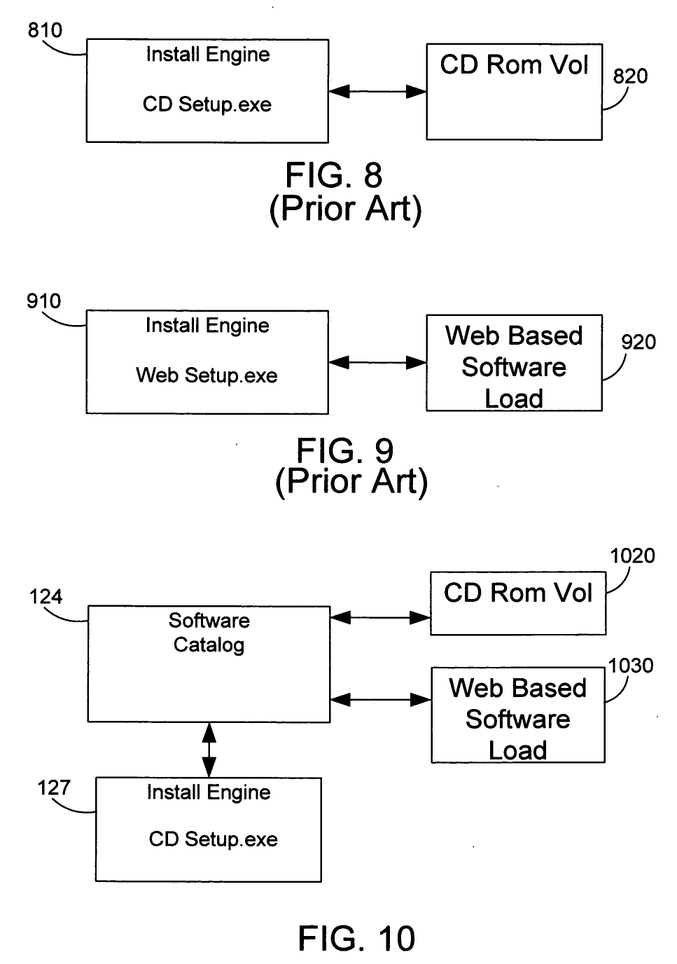

Prior art software distribution and installation is typically done by CD or over a network. FIG. 8 represents a prior art software installation from a CD. An install engine 810 loads software from a CD. The install program is illustrated as “CD Setup.exe” which represents a typical software installation program used for loading software from the CD. FIG. 9 represents a prior art software installation from a Web bases source. An install engine 910 loads software from a web based software load 920. The install program is illustrated as “Web Setup.exe” which represents a typical software installation program used for loading software from the web. Typically the prior art web based software load 920 is specially formatted for installation.

FIG. 10 represents a software catalog 124 that uses an install engine 127 according to preferred embodiments. The software catalog uses the install engine 127 to load software from a CD ROM volume 1020 or from a web based software load 1030 using the same install program by passing the CD ROM volume 120 or the web based software load 1030 to the install program. In the illustration, the install program is represented as “CD Setup.exe.” In this way, a proxy entry allows the target software in a software catalog to be similar in packaging to current software distributed on CD's rather than specially formatted for distribution over the network, or in any single format because the same install program in the install engine is used. The proxy link contains the installation information for the target software in the same format as that is commonly used to distribute software on CD's. This allows software vendors to simplify their fulfilment channels as well as their development costs by having a single software build and a single installer. The software catalog is used to perform installation of the software, and acts as the source image for the software install engine that is used for a typical software installation.

A prior art desktop link has a similar appearance to a proxy link, but it is quite different in operation and content. A prior art desktop link could point to a target software. The target software would then need to be an executable that understands its own packaging and is capable of deploying itself. This means the target software is specially packaged to be downloaded. In contrast, the proxy link contains the install information to pass to an install engine, and the target software load can be in a typical format such as in the form of a CD volume as described in the above paragraphs.

In the above paragraphs, the software associated with a proxy entry was installed in the materialization process. There may be reasons and times that it is desirable to reverse the materialization of the proxy entries. For example, the software catalog may include a timer routine that determines the elapsed time since an application is used, and according to preset times, dematerializes software that has not been used for a period greater than the present times. This would save space on the computer storage device. When the software of CD Image 3 shown in FIG. 7 is de-materialized, the software catalog would again appear as shown in FIG. 6.

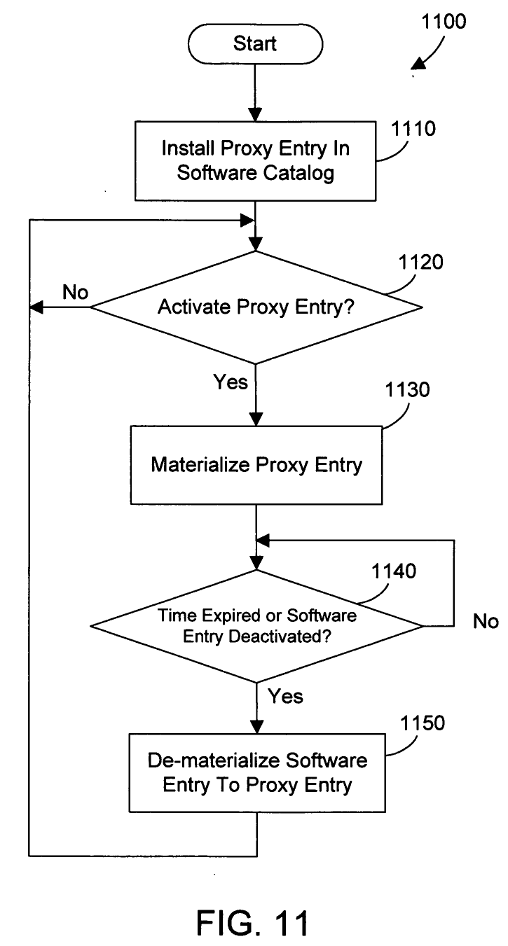

Referring now to FIG. 11, method 1100 is illustrated for using a proxy entry in accordance with the preferred embodiments. Method 1100 first allows the user to install a proxy entry in the software catalog (step 1110). When the proxy entry is activated (step 1120=yes) the proxy entry is materialized into an installed software entry in the software catalog (step 1130). If the proxy entry is not activated (step 1120=no), the method returns to step 1120. After the proxy entry is materialized (step 1130), the software associated with the proxy entry stays active and available if a time limit is not expired or the proxy is not deactivated (step 1140=no). If the time limit expires, or the proxy is deactivated (step 1140=yes) then the software entry in the catalog is dematerialized back to a proxy entry (step 1150). The method then returns to step 1120 and operates in the loop as long as the software catalog is active.

The present invention as described with reference to the preferred embodiments provides significant improvements over the prior art. The described apparatus and method improve order fulfilment and the management of installed software on a computer system by providing a software catalog with one or more proxy entries to a CD image stored on a system resource. The described embodiments allow computer software users to efficiently manage software installation and product fulfilment. Described embodiments also allow software vendors to reduce product installation and distribution costs.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a software catalog residing in the memory; and
a proxy entry in the software catalog that contains location and installation information for corresponding software located in a software install image accessible by the processor from a computer resource.

2. The apparatus of claim 1 wherein the proxy entry can be activated to materialize into an image of the corresponding software from a CD volume image.

3. The apparatus of claim 1 wherein the proxy entry is immediately displayed in the software catalog when the proxy entry is downloaded from an internet source upon the purchase by a user and the software is installed subsequently when the proxy entry is materialized.

4. The apparatus of claim 1 wherein the proxy entry is displayed in a user interface which includes a visual representation if the proxy has been materialized.

5. The apparatus of claim 4 wherein the visual representation is a change in a graphics icon.

6. The apparatus of claim 1 wherein the proxy entry includes ownership information and a certificate to validate the ownership information.

7. The apparatus of claim 6 wherein the ownership information and a certificate to validate the right to limited use of the software with respect to time and features of the software.

8. A method for installing software on a computer system, the method comprising the steps of:
providing a software catalog;
including at least one proxy entry in the software catalog;
allowing a user to initiate activating the proxy entry; and
materializing the proxy entry into an image of corresponding software in response to the activating step by the user.

9. The method of claim 8 further comprising the step of dematerializing the software back to a proxy entry.

10. The method of claim 9 wherein the step of dematerializing is initiated by the expiration of a timer setting.

11. The method of claim 9 wherein the step of dematerializing is initiated by the user.

12. A program product comprising:
(A) a software catalog that includes at least one proxy entry that contains location and installation information for corresponding software located in a software image accessible from a computer resource; and
(B) computer-readable signal bearing media bearing the software catalog.

13. The program product of claim 12 wherein the computer-readable signal bearing media comprises recordable media.

14. The program product of claim 12 wherein the computer-readable signal bearing media comprises transmission media.

15. The program product of claim 12 wherein the at least one proxy entry can be activated to materialize into an image of the corresponding software from a CD volume image.

16. The program product of claim 12 wherein the proxy entry is immediately displayed in the software catalog when the proxy entry is downloaded from an internet source upon the purchase by a user and the software is installed subsequently when the proxy entry is materialized.

17. The program product of claim 12 wherein the proxy entry is displayed in a user interface which includes a visual representation if the proxy has been materialized.

18. The apparatus of claim 17 wherein the visual representation is a change in a graphics icon.

19. The program product of claim 12 wherein the proxy entry includes ownership information and a certificate to validate the ownership information.

20. The program product of claim 19 wherein the ownership information and a certificate to validate the right to limited use of the software with respect to time and features of the software.
